(19) United States
(12) Patent Application Publication
(10) Pub. No.: US 2013/0260606 A1
(43) Pub. Date: Oct. 3, 2013

(54) ROBOT SYSTEM AND ROBOT

(71) Applicant: SEIKO EPSON CORPORATION, Tokyo (JP)

(72) Inventors: Seiji HAHAKURA, Suwa (JP); Takuya OWA, Matsumoto (JP)

(73) Assignee: Seiko Epson Corporation, Tokyo (JP)

(21) Appl. No.: 13/854,233

(22) Filed: Apr. 1, 2013

(30) Foreign Application Priority Data
Apr. 2, 2012 (JP) 2012-084353

(51) Int. Cl. H01R 13/60

(52) U.S. Cl. CPC H01R 13/60; Y10S 901/15
USPC 439/534; 901/15

(57) ABSTRACT

A robot includes a connector receiving portion to which a connector is connected, the connector having a hollow connector housing and first packing and second packing that maintain the hermeticity of the connector housing. The robot further includes an arm and an arm that are coupled to each other. Each arm is supported in such a way as to be rotatable about a rotation axis. Moreover, the connector receiving portion is placed in the arm in such a way that a direction in which the connector connected to the connector receiving portion is drawn coincides with a direction of the rotation axis.

### BACKGROUND

1. Technical Field

The present invention relates to robot systems and robots.

2. Related Art

In the past, a robot that is placed in a germ-free workroom filled with corrosive sterilizing gas such as hydrogen peroxide vapor and performs various operations has been known (for example, see JP-A-2005-205576 (hereinafter Patent Document 1)). Such a robot has corrosion resistance so that the sterilizing gas does not enter the robot and corrode a motor, wiring, and the like. Moreover, as a connector connected to the robot, a large connector having a sealing member such as packing is used to prevent internal corrosion.

Furthermore, in the past, a robot provided with a base and a robot arm that is supported in such a way that the robot arm can be displaced with respect to the base has been known (for example, see JP-A-2010-76056 (hereinafter Patent Document 2)). In the robot described in Patent Document 2, the robot arm is formed of six arms (a first arm, a second arm, a third arm, a fourth arm, a fifth arm, and a sixth arm) coupled in order from the base. To the sixth arm located at the extreme tip, a camera can be attached. This camera is connected, via a flexible cable, to a connector placed in the fourth arm. The cable is drawn from the connector upward and extends toward the camera.

However, in such a cable routing mode (a direction in which a cable is drawn), when a connector having packing is used, depending on, for example, the height of the ceiling of a room in which the robot is placed, the ceiling and the cable collide with each other (make contact with each other). In this case, with the movement of the robot arm, the cable breaks due to the friction between the cable and the ceiling. Moreover, when the arm rotates, since the other arm and the cable collide with each other, the operating range of the robot arm becomes narrow.

### SUMMARY

An advantage of some aspects of the invention is to provide a robot system and a robot that can route a flexible long object, such as a cable, connected to a connector with ease.

An aspect of the invention is directed to a robot system including: a connector having a hollow connector housing and packing that maintains the hermeticity of the connector housing; and a robot provided with a connector receiving portion to which the connector is connected, the robot includes two arms coupled to each other, one arm of the two arms being supported in such a way as to be rotatable about a first rotation axis and the other arm being supported in such a way as to be rotatable about a second rotation axis intersecting the first rotation axis, and the connector receiving portion is placed in the one arm in such a way that a direction in which the connector connected to the connector receiving portion is drawn coincides with a direction of the second rotation axis.

With this configuration, if a flexible long object such as a cable is connected to the connector, when the connector is connected to the connector receiving portion, a direction in which the long object (the connector) is drawn reliably coincides with the direction of the second rotation axis. Such a direction in which the long object (the connector) is drawn allows the cable to be routed easily with no consideration given to the interference between the area around the robot and the long object.

Another aspect of the invention is directed to a robot provided with a connector receiving portion to which a connector is connected, the connector having a hollow connector housing and packing that maintains the hermeticity of the connector housing, the robot including two arms coupled to each other, one arm of the two arms is supported in such a way as to be rotatable about a first rotation axis and the other arm is supported in such a way as to be rotatable about a second rotation axis intersecting the first rotation axis, and the connector receiving portion is placed in the one arm in such a way that a direction in which the connector connected to the connector receiving portion is drawn coincides with a direction of the second rotation axis.

With this configuration, if a flexible long object such as a cable is connected to the connector, when the connector is connected to the connector receiving portion, a direction in which the long object (the connector) is drawn reliably coincides with the direction of the second rotation axis. Such a direction in which the long object (the connector) is drawn allows the cable to be routed easily with no consideration given to the interference between the area around the robot and the long object.

In the robot according to the aspect of the invention, it is preferable that the connector receiving portion is formed separately from the one arm and has a hollow connector receiving portion body and at least one piece of packing for a connector receiving portion, the packing maintaining the hermeticity of the connector receiving portion body.

with this configuration, the hermeticity of the connector receiving portion body is reliably maintained, making it possible to reliably prevent gas or liquid from entering the connector receiving portion body from the outside.

In the robot according to the aspect of the invention, it is preferable that the connector receiving portion is placed on an outer surface of the one arm and the connector receiving portion body has a first opening formed in such a way as to face the outer surface of the one arm and a second opening formed in such a way as to face in the direction of the second rotation axis.

With this configuration, if a flexible long object such as a cable is connected to the connector, when the connector is connected to the connector receiving portion, a direction in which the long object is drawn reliably coincides with the direction of the second rotation axis. As compared to a case in which the long object is drawn vertically upward, for example, a mode in which the direction in which the long object is drawn coincides with the direction of the second rotation axis makes it possible to route the cable easily with no consideration given to the interference between the area around the robot and the cable.

In the robot according to the aspect of the invention, it is preferable that the packing for a connector receiving portion is placed in the first opening and the packing for a connector receiving portion is placed in the second opening.

With this configuration, the hermeticity of the connector receiving portion body is reliably maintained, making it possible to reliably prevent gas or liquid from entering the connector receiving portion body from the outside.

In the robot according to the aspect of the invention, it is preferable that the other arm has one end portion to which the one arm is coupled and the other end portion to which an arm for manipulator attachment, the arm to which a manipulator electrically connected to the connector is attached, is coupled.

The operating range (the rotation range) of the one arm is narrower than the operating range (the rotation range) of the other arm. That is, while the one arm rotates about the first rotation axis, the other arm rotates about the first rotation axis with the one arm in addition to rotating about the second rotation axis. As described above, when a flexible long object such as a cable is connected to the connector, providing the connector receiving portion in the one arm with a narrower operating range is preferable for the long object.

In the robot according to the aspect of the invention, it is preferable that the other arm is a long object extending in the direction of the second rotation axis.

With this configuration, it is possible to change the position of the manipulator appropriately depending on the shape and the size of an object to be held by the manipulator attached to the arm for manipulator attachment and thereby hold the object easily and reliably.

In the robot according to the aspect of the invention, it is preferable that the connector receiving portion is electrically connected to a supply source that supplies electric power to the manipulator.

With this configuration, it is possible to supply electric power to the manipulator from the supply source in a state in which the connector is connected to the connector receiving portion and thereby operate the manipulator.

In the robot according to the aspect of the invention, it is preferable that the first rotation axis and the second rotation axis intersect at right angles.

For example, when the other arm is a long object extending in the second rotation axis and the one arm is coupled to one end portion thereof and the arm for manipulator attachment, the arm to which the manipulator electrically connected to the connector is attached, is coupled to the other end portion, it is possible to place the manipulator attached to the arm for manipulator attachment in a desired position.

In the robot according to the aspect of the invention, it is preferable that the connector housing is formed as a cylinder and the packing is placed at both ends of the cylinder.

With this configuration, the hermeticity of the connector housing is reliably maintained, making it possible to reliably prevent gas or liquid from entering the connector housing from the outside.

### BRIEF DESCRIPTION OF THE DRAWINGS

The invention will be described with reference to the accompanying drawings, wherein like numbers reference like elements.

FIG. 1 is a perspective view of a robot (a robot system) of an embodiment of the invention viewed from the front.

FIG. 2 is a perspective view of the robot (the robot system) of the embodiment of the invention viewed from the back.

FIG. 3 is an enlarged view of an upper portion of the robot (the robot system) of the embodiment of the invention.

FIG. 4 is a schematic diagram of the robot of the embodiment of the invention.

FIG. 5 is a block diagram of a principal portion of the robot (the robot system) of the embodiment of the invention.

FIG. 6 is a perspective view showing a usage state (a placement state) of the robot (the robot system) of the embodiment of the invention.

FIG. 7 is an exploded perspective view of a typical arm of a plurality of arms of the robot of the embodiment of the invention.

FIGS. 8A and 8B are sectional views taken on the line A-A in FIG. 7.

FIG. 9 is a sectional view taken on the line B-B in FIG. 7.

FIG. 10 is an enlarged sectional view of a frame of the robot of the embodiment of the invention.

FIG. 11 is a sectional view taken on the line C-C in FIG. 7.

FIG. 12 is a diagram (a side view) of the arm of FIG. 7 viewed from the direction of an arrow D.

FIG. 13 is a sectional view taken on the line E-E in FIG. 3 (a diagram showing a connection state).

FIG. 14 is a sectional view taken on the line E-E in FIG. 3 (a diagram showing a disconnection state).

### DESCRIPTION OF EXEMPLARY EMBODIMENTS

Hereinafter, based on a preferred embodiment of the invention shown in the attached drawings, a robot system and a robot of the embodiment of the invention will be described in detail.

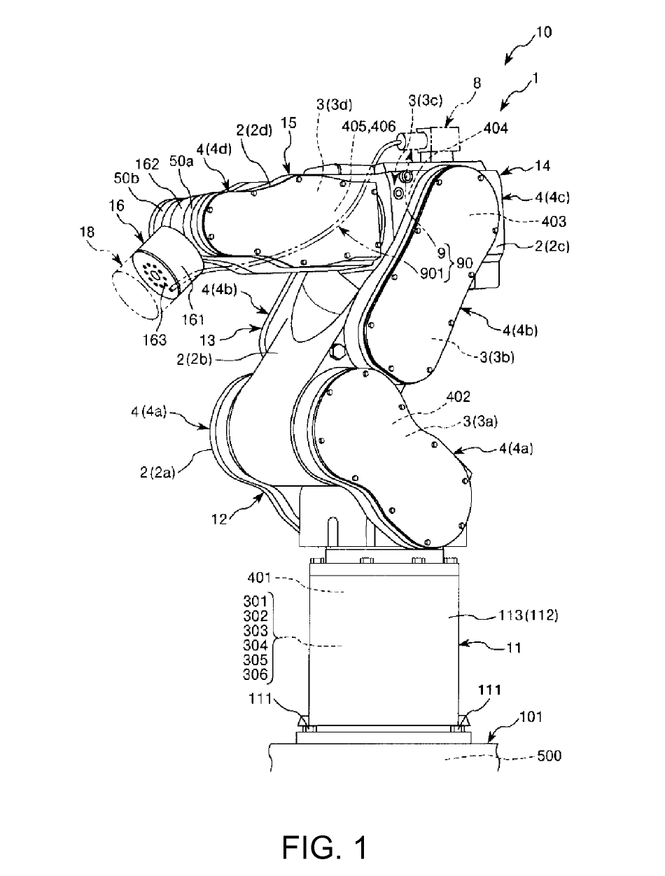

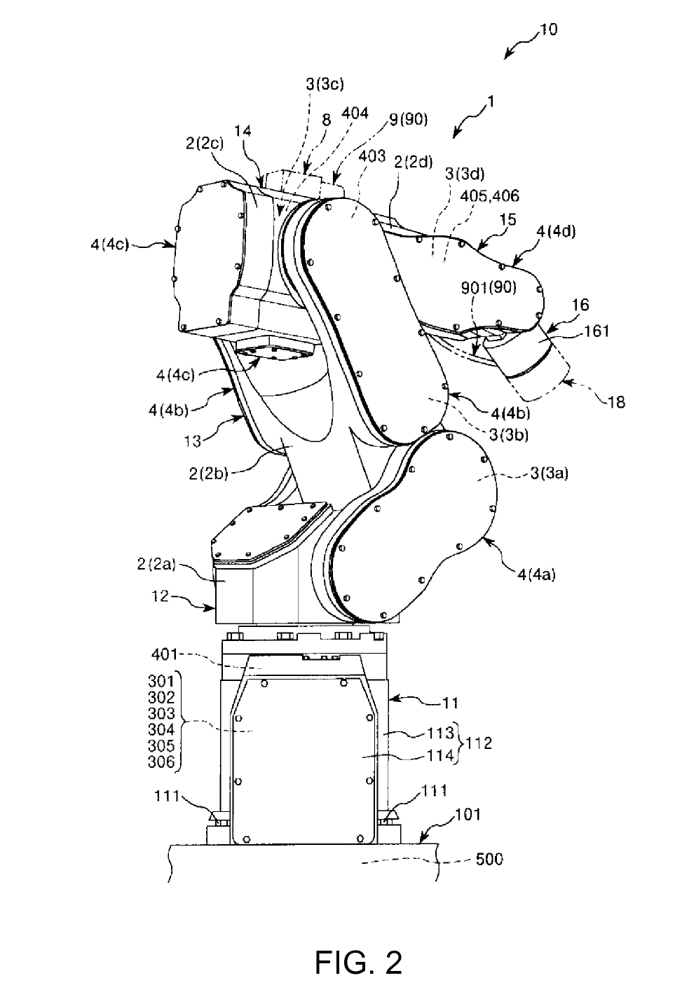

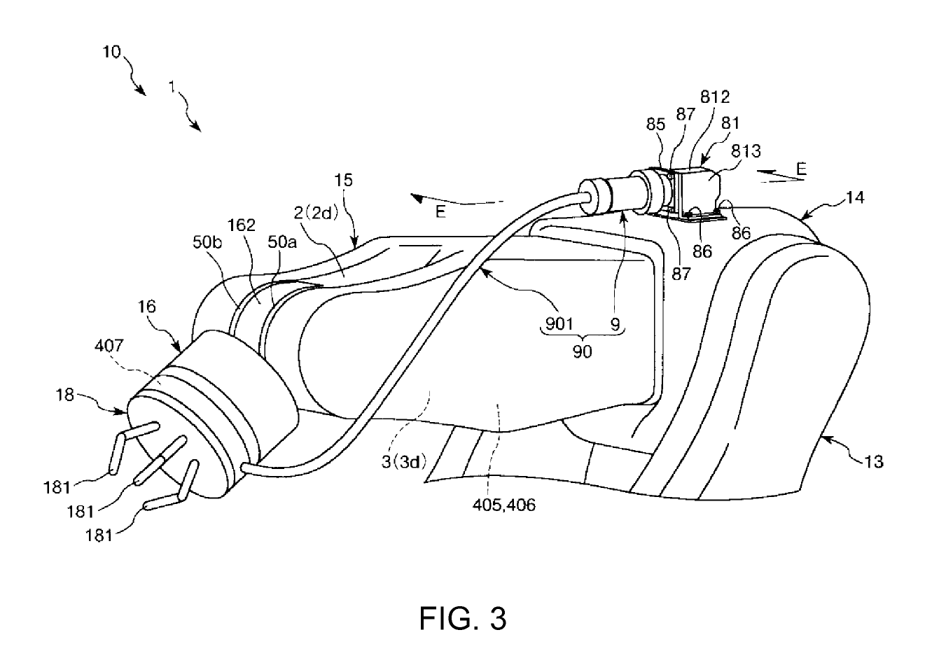

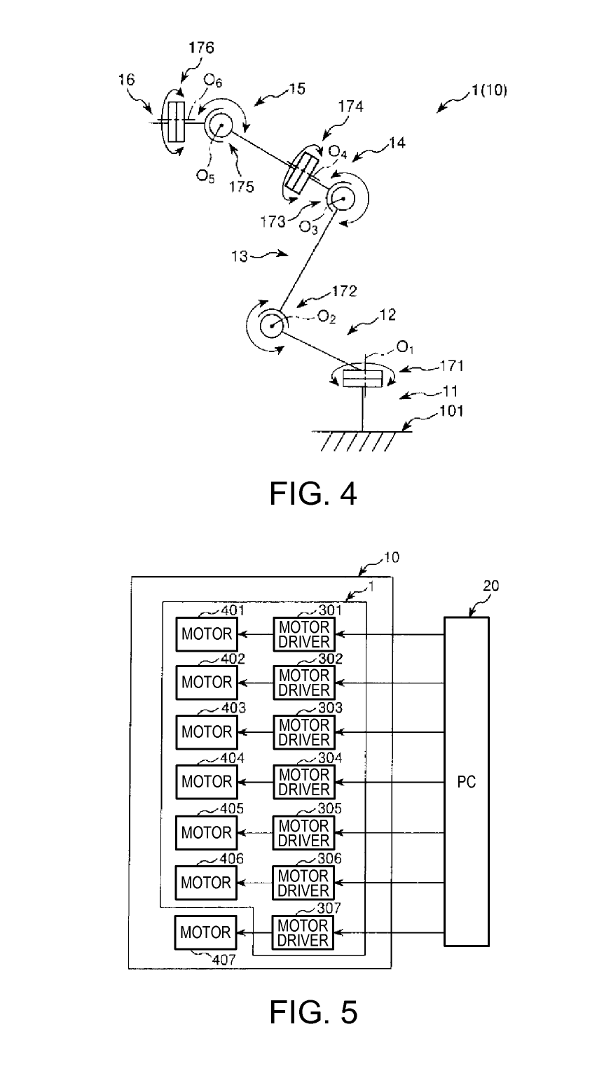

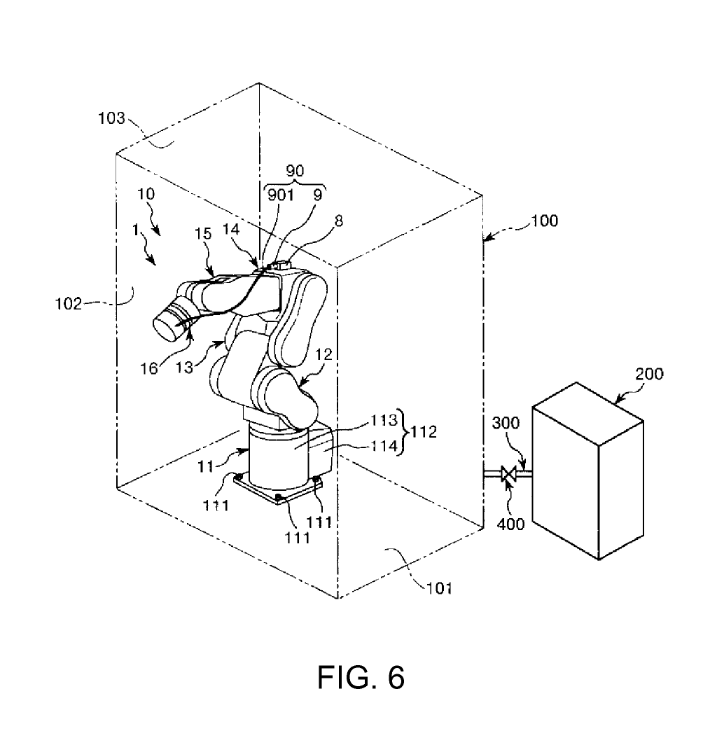

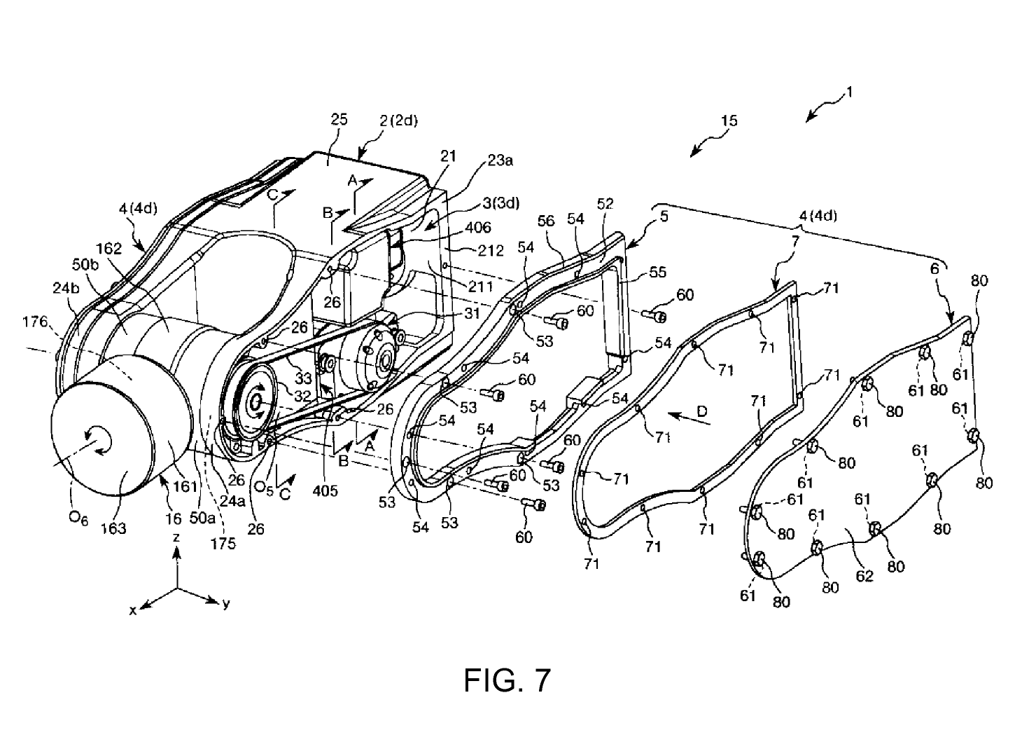

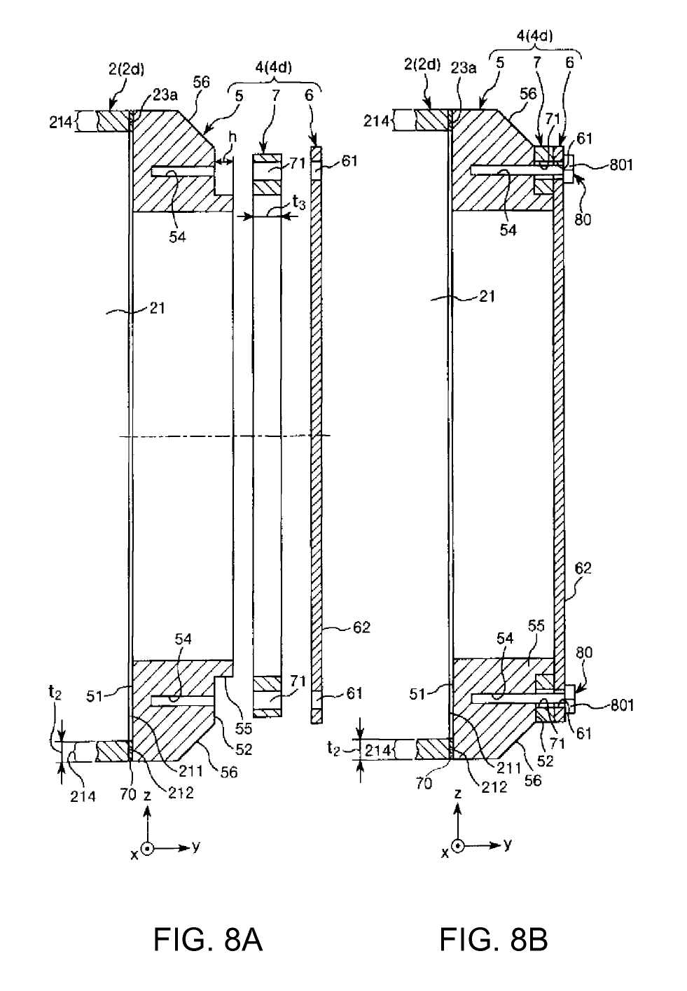

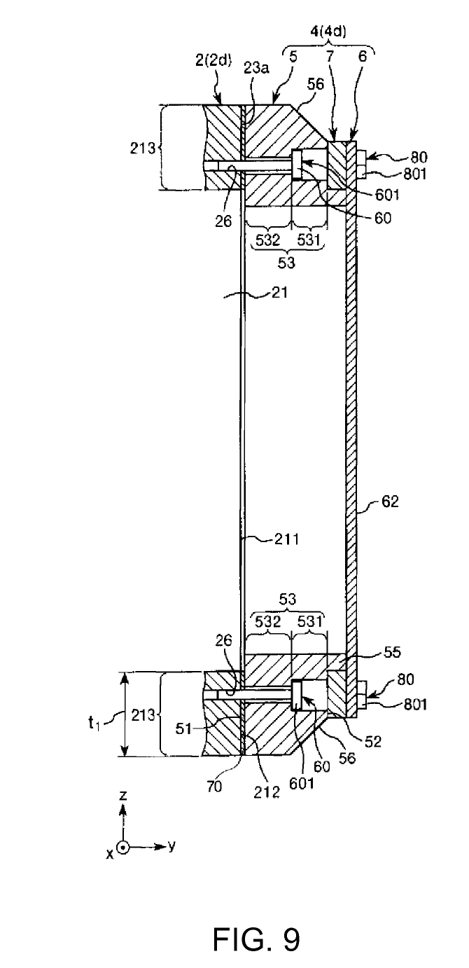

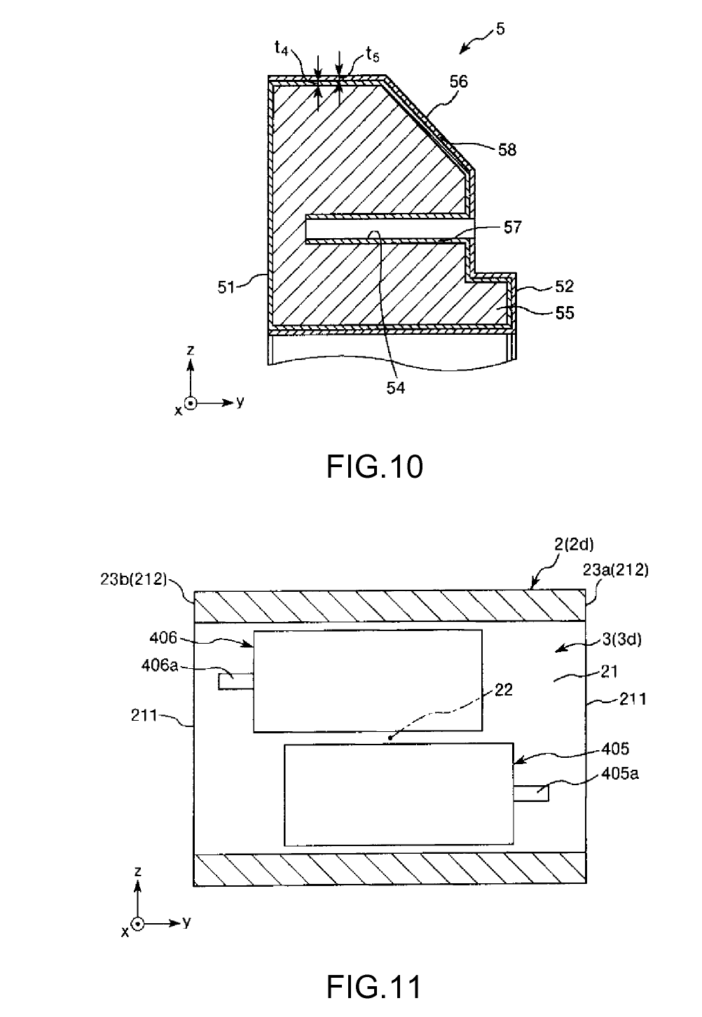

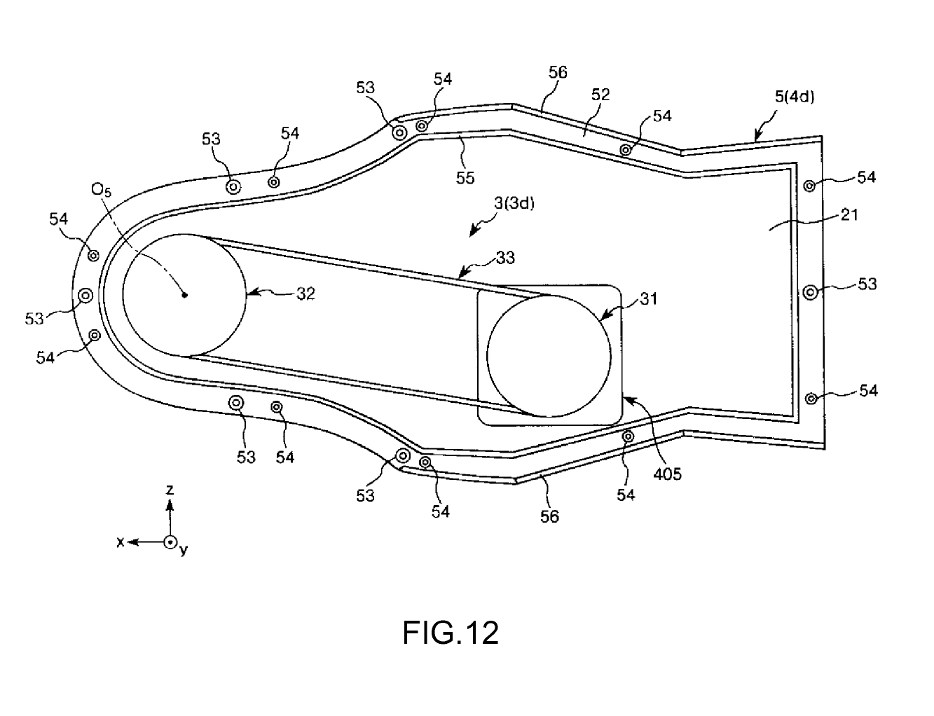

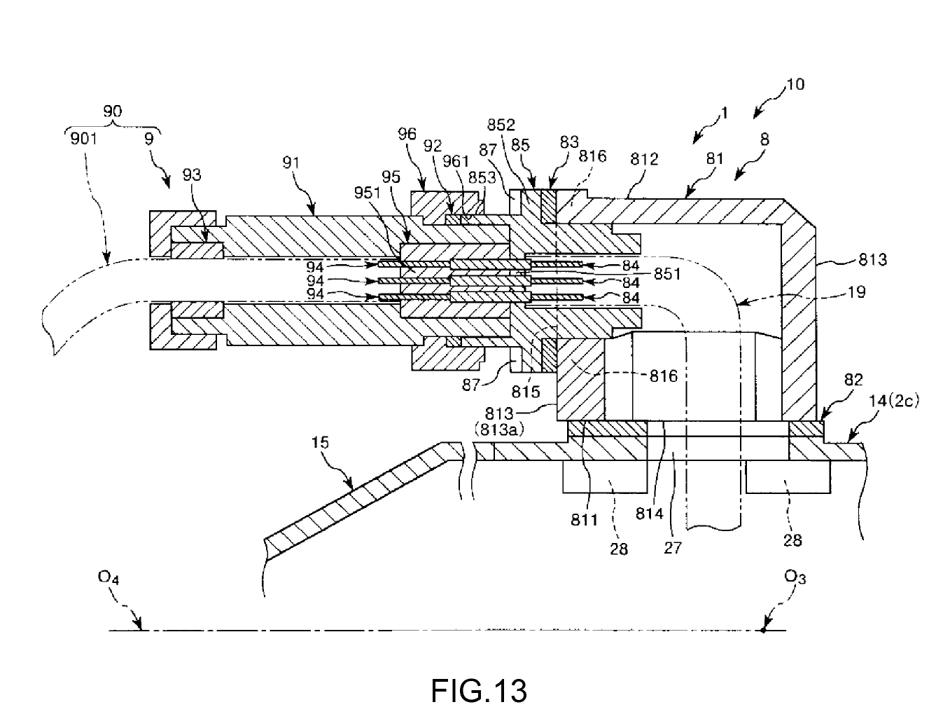

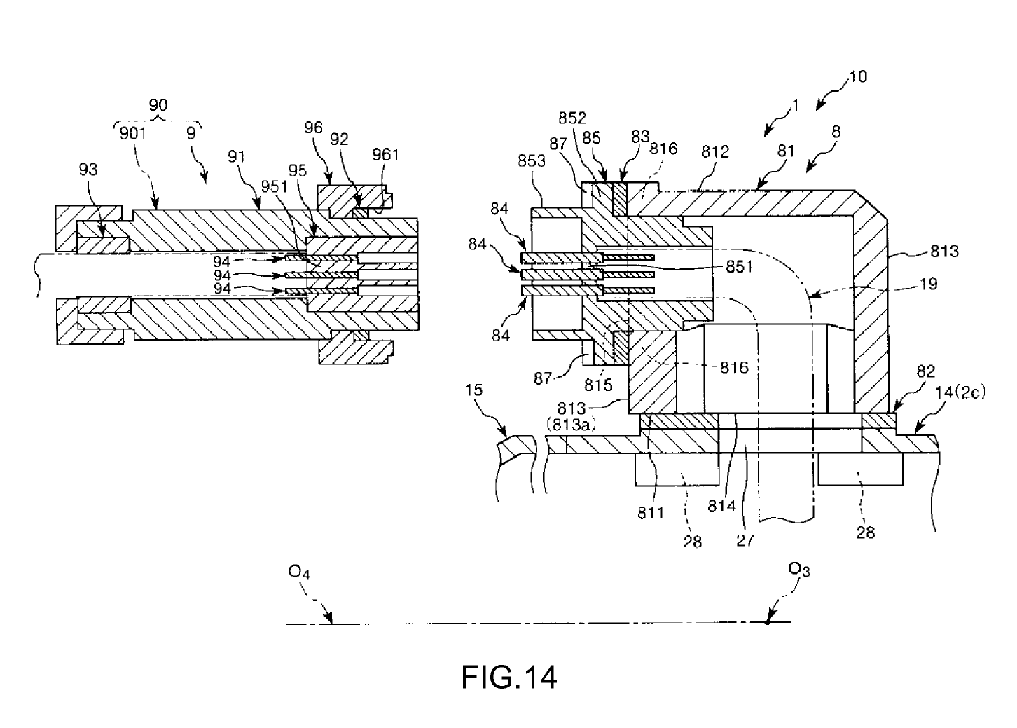

FIG. 1 is a perspective view of a robot (a robot system) of the embodiment of the invention viewed from the front, FIG. 2 is a perspective view of the robot (the robot system) of the embodiment of the invention viewed from the back, FIG. 3 is an enlarged view of an upper portion of the robot (the robot system) of the embodiment of the invention, FIG. 4 is a schematic diagram of the robot of the embodiment of the invention, FIG. 5 is a block diagram of a principal portion of the robot (the robot system) of the embodiment of the invention, FIG. 6 is a perspective view showing a usage state (a placement state) of the robot (the robot system) of the embodiment of the invention, FIG. 7 is an exploded perspective view of a typical arm of a plurality of arms of the robot of the embodiment of the invention, FIGS. 8A and 8B are sectional views taken on the line A-A in FIG. 7, FIG. 9 is a sectional view taken on the line B-B in FIG. 7, FIG. 10 is an enlarged sectional view of a frame of the robot of the embodiment of the invention, FIG. 11 is a sectional view taken on the line C-C in FIG. 7, FIG. 12 is a diagram (a side view) of the arm of FIG. 7 viewed from the direction of an arrow D, and FIGS. 13 and 14 are sectional views taken on the line E-E in FIG. 3 (FIG. 13 showing a connection state and FIG. 14 showing a disconnection state). Incidentally, hereinafter, for convenience of explanation, an upper side in FIGS. 1 to 5 and FIGS. 6 to 13 is referred to as “upper” or “above” and a lower side is referred to as “lower” or “below”. Moreover, a base side in FIGS. 1 to 4 and FIG. 6 is referred to as a “base end” and an opposite side is referred to as a “tip”. Furthermore, a longitudinal direction of an arm in FIGS. 7 to 12 is referred to as an “x-axis direction”, a direction which is perpendicular and parallel to the x-axis direction is referred to as a “y-axis direction”, and a direction perpendicular to both the x-axis direction and the y-axis direction is referred to as a “z-axis direction”.

As shown in FIGS. 1 to 3, a robot system 10 provided with a robot (an industrial robot) 1 and a connector assembly (a connector 9) connected to the robot 1 (a connector receiving portion 8) can be used in an inspection process in which a precision apparatus such as a wristwatch is inspected.

The robot 1 is a vertical jointed-arm (six-axis) robot in which a base 11, four arms (links) 12, 13, 14, and 15, and a wrist (a link) 16 are coupled in order. Incidentally, in the vertical jointed-arm robot, the base 11, the arms 12 to 15, and the wrist 16 can be collectively called an “arm”. The base 11 can be called a “first arm”, the arm 12 can be called a “second arm”, the arm 13 can be called a “third arm”, the arm 14 can be called a “fourth arm”, the arm 15 can be called a “fifth arm”, and the wrist 16 can be called a “sixth arm”.

As shown in FIG. 4, the arms 12 to 15 and the wrist 16 are independently supported in such a way that the arms 12 to 15 and the wrist 16 can be displaced independently with respect to the base 11.

The base 11 and the arm 12 are coupled to each other via a joint 171. The arm 12 can rotate about a rotation axis O₁ with respect to the base 11, the rotation axis O₁ parallel to a vertical direction. The rotation about the rotation axis O₁ is performed by the driving of a motor 401. Incidentally, the driving of the motor 401 is controlled by a motor driver 301 electrically connected to the motor 401 via a cable (not shown) (see FIG. 5).

The arm 12 and the arm 13 are coupled to each other via a joint 172. The arm 13 can rotate about a rotation axis O₂ with respect to the arm 12 (the base 11), the rotation axis O₂ parallel to a horizontal direction. The rotation about the rotation axis O₂ is performed by the driving of a motor 402. Incidentally, the driving of the motor 402 is controlled by a motor driver 302 electrically connected to the motor 402 via a cable (not shown) (see FIG. 5).

The arm 13 and the arm 14 are coupled to each other via a joint 173. The arm 14 can rotate about a rotation axis O₃ (a first rotation axis) with respect to the arm 13 (the base 11), the rotation axis O₃ (the first rotation axis) parallel to a horizontal direction. The rotation about the rotation axis O₃ is performed by the driving of a motor 403. Incidentally, the driving of the motor 403 is controlled by a motor driver 303 electrically connected to the motor 403 via a cable (not shown) (see FIG. 5).

The arm 14 (one arm) and the arm 15 (the other arm) are coupled to each other via a joint 174. The arm 15 can rotate about a rotation axis O₄ (a second rotation axis) with respect to the arm 14 (the base 11), the rotation axis O₄ (the second rotation axis) which is parallel to the central axis direction of the arm 14, that is, which is orthogonal to (intersects) the rotation axis O₃. The rotation about the rotation axis O₄ is performed by the driving of a motor 404. Incidentally, the driving of the motor 404 is controlled by a motor driver 304 electrically connected to the motor 404 via a cable (not shown) (see FIG. 5).

The arm 15 and the wrist 16 are coupled to each other via a joint 175. The wrist 16 can rotate about a rotation axis O₅ with respect to the arm 15 (the base 11), the rotation axis O₅ parallel to a horizontal direction (the y-axis direction). The rotation about the rotation axis O₅ is performed by the driving of a motor 405. Incidentally, the driving of the motor 405 is controlled by a motor driver 305 electrically connected to the motor 405 via a cable (not shown) (see FIG. 5). Moreover, the wrist 16 can rotate also about a rotation axis O₆ perpendicular to the rotation axis O₅ via a joint 176. The rotation about the rotation axis O₆ is performed by the driving of a motor 406. Incidentally, the driving of the motor 406 is controlled by a motor driver 306 electrically connected to the motor 406 via a cable (not shown) (see FIG. 5).

As described above, as a result of the rotation axes to O₆ having positional relationships “parallel”, “orthogonal”, and “skew”, a manipulator 18, which will be described later, can be disposed in a desired position.

Incidentally, the motors 401 to 406 are not limited to a particular motor, and it is preferable to use a servomotor, for example. Moreover, each cable is placed through the robot 1.

As shown in FIG. 5, the robot 1 is electrically connected to a personal computer (PC) 20 as a control unit, the personal computer having a built-in CPU (central processing unit). The personal computer 20 can operate the arms 12 to 15 and the wrist 16 independently. That is, the personal computer 20 can control the motors 401 to 406 independently via the motor drivers 301 to 306. The control program is stored in advance in a recording medium built into the personal computer 20.

As shown in FIG. 6, in this embodiment, the robot 1 is placed in a chamber (an isolator) 100 that does not permit the passage of air. The chamber 100 communicates with, via a pipe 300, a sterilizing gas generating apparatus 200 that generates sterilizing gas (for example, hydrogen peroxide vapor). The robot 1 undergoes sterilization by the sterilizing gas from the sterilizing gas generating apparatus 200 before and after the operation. Incidentally, the pipe 300 is provided with a valve 400 located midway in the longitudinal direction of the pipe 300. The valve 400 switches between a communicating state in which the chamber 100 and the sterilizing gas generating apparatus 200 communicate with each other and an interrupted state in which the communicating state is interrupted.

As described earlier, the robot 1 includes the base 11, the arms 12 to 15, and the wrist 16.

As shown in FIGS. 1 and 2, when the robot 1 is a vertical jointed-arm robot, the base 11 is a portion which is located in the lowermost part of the vertical jointed-arm robot and fixed to a floor 101 of the chamber 100. The fixing method is not limited to a particular method, and, for example, in this embodiment shown in FIGS. 1 and 2, a fixing method by a plurality of bolts 111 is used. Incidentally, as a position in the chamber 100 in which the base 11 is fixed, in addition to the floor 101, a wall 102 and a ceiling 103 of the chamber 100 can also be adopted.

The base 11 has a hollow base body (a housing) 112. The base body 112 can be divided into a cylindrical portion 113 and a box-shaped portion 114 formed integrally with the outer periphery of the cylindrical portion 113. In such a base body 112, the motor 401 and the motor drivers 301 to 306, for example, are accommodated.

The arms 12 to 15 each have a hollow arm body 2, a drive mechanism 3, and a sealing unit 4 and have almost the same structure except for a placement area with respect to the base 11, that is, a placement area in the entire robot 1, and the outer shape. Incidentally, hereinafter, for convenience of explanation, the arm body 2, the drive mechanism 3, and the sealing unit 4 of the arm 12 are sometimes referred to as an “arm body 2a”, a “drive mechanism 3a”, and a “sealing unit 4a”, respectively, the arm body 2, the drive mechanism 3, and the sealing unit 4 of the arm 13 are sometimes referred to as an “arm body 2b”, a “drive mechanism 3b”, and a “sealing unit 4b”, respectively, the arm body 2, the drive mechanism 3, and the sealing unit 4 of the arm 14 are sometimes referred to as an “arm body 2c”, a “drive mechanism 3c”, and a “sealing unit 4c”, respectively, and the arm body 2, the drive mechanism 3, and the sealing unit 4 of the arm 15 are sometimes referred to as an “arm body 2d”, a “drive mechanism 3d”, and a “sealing unit 4d”, respectively.

The arm 12 has a base end portion coupled to an upper end portion (a tip portion) of the base 11 in a position in which the base end portion is inclined with respect to a horizontal direction. In the arm 12, the drive mechanism 3a having the motor 402 is accommodated in the arm body 2a. Moreover, the arm body 2a is hermetically sealed by the sealing unit 4a.

The arm 13 has a base end portion coupled to the tip of the arm 12. In the arm 13, the drive mechanism 3b having the motor 403 is accommodated in the arm body 2b. Moreover, the arm body 2b is hermetically sealed by the sealing unit 4b.

The arm 14 has a base end portion coupled to the tip of the arm 13. In the arm 14, the drive mechanism 3c having the motor 404 is accommodated in the arm body 2c. Moreover, the arm body 2c is hermetically sealed by the sealing unit 4c.

The arm 15 has a base end portion (one end portion) coupled to a tip portion of the arm 14 in such a way that the base end portion (the one end portion) becomes parallel to the central axis direction of the arm 14. The arm 15 is long in the direction of the rotation axis O₄, and the drive mechanism 3d having the motors 405 and 406 is accommodated in the arm body 2d. Moreover, the arm body 2d is hermetically sealed by the sealing unit 4d.

To a tip portion (the other end portion) of the arm 15, the wrist 16 is coupled. As shown in FIG. 3, to a tip portion (an end on the opposite side of the arm 15) of the wrist 16, as an end factor, the manipulator 18 that holds a precision apparatus such as a wristwatch is removably attached. As described above, the wrist 16 functions as an arm for manipulator attachment to which the manipulator 18 can be removably attached.

Incidentally, the manipulator 18 is not limited to a particular manipulator, and examples include a manipulator having a plurality of (in the structure shown in FIG. 3, three) finger portions (fingers) 181. The finger portions 181 can collectively move closer to one another and move away from one another by the driving of a motor 407 which is built into the manipulator 18. The robot 1 can convey the precision apparatus by controlling the movements of the arms 12 to 15, the wrist 16, and the like while holding the precision apparatus between the finger portions 181 which are close to one another. The driving of the motor 407 is controlled by a motor driver 307 electrically connected to the motor 407 via a cable (not shown) (see FIG. 5).

As shown in FIG. 7, the wrist 16 has a cylindrical wrist body 161 and a ring-shaped supporter ring 162 that is formed separately from the wrist body 161 and is provided at the base end portion of the wrist body 161.

A tip surface 163 of the wrist body 161 is a flat face and serves as a face to which the manipulator is attached. Moreover, the wrist body 161 is coupled to the drive mechanism 3d of the arm 15 and rotates about the rotation axis O₆ by the driving of the motor 406 of the drive mechanism 3d.

The supporter ring 162 is coupled to the drive mechanism 3d of the arm 15 and rotates about the rotation axis O₅ with the wrist body 161 by the driving of the motor 405 of the drive mechanism 3d.

Next, the arms 12 to 15 will be described in detail. As described earlier, since these arms 12 to 15 have almost the same structure except for a placement area in the entire robot 1 and the outer shape, only the arm 15 will be described as a typical example.

As shown in FIG. 7, the arm 15 has the arm body 2 (2d), the drive mechanism 3 (3d), and the sealing unit 4 (4d).

The arm body 2 is formed as a long object extending in the x-axis direction, and the long object is formed of a pair of tongue-shaped portions 24a and 24b on the tip side and a root portion 25 on the base end side. The tongue-shaped portion 24a and the tongue-shaped portion 24b are away from each other in the y-axis direction. Between the tongue-shaped portion 24a and the tongue-shaped portion 24b, the supporter ring 162 of the wrist 16 is placed. Furthermore, between the tongue-shaped portion 24a and the supporter ring 162, a cylindrical member 50a is inserted, and, between the tongue-shaped portion 24b and the supporter ring 162, a cylindrical member 50b is inserted. As a result, the wrist 16 is held by the arm 15.

Moreover, the arm body 2 has an accommodating section 21 that accommodates the drive mechanism 3. The accommodating section 21 is formed as a recess formed in two side faces 23a and 23b (outer surfaces) placed with a central axis 22 of the arm body 2 located between the side faces 23a and 23b (see FIG. 11). As a result, when maintenance of the drive mechanism 3 is performed, the maintenance can be performed from both the side where the side face 23a is located and the side where the side face 23b is located. For example, when the motor 405 is replaced with the new one, the motor 405 can be replaced with the new one from the side where the side face 23a is located, and, when the motor 406 is replaced with the new one, the motor 406 can be replaced with the new one from the side where the side face 23b is located. As described above, the robot 1 facilitates maintenance.

The constituent material of the arm body 2 is not limited to a particular material, and, for example, various metal materials can be used. Of these metal materials, aluminum or an aluminum alloy is particularly preferable. When the arm body 2 is a casting molded by using a mold, by using aluminum or an aluminum alloy as the constituent material of the arm body 2, it is possible to perform molding by using the mold with ease.

Incidentally, as the constituent material of the base body 112 of the above-mentioned base 11 and the constituent material of the supporter ring 162 of the wrist 16, a material similar to the constituent material of the arm body 2 can also be used. Moreover, it is preferable to use stainless steel as the constituent material of the wrist body 161 of the wrist 16.

As shown in FIGS. 7 and 11, the drive mechanism 3 has the motors 405 and 406. The motors 405 and 406 are both located in the accommodating section 21 on the side where the root portion 25 is located, that is, on the side where the base 11 is located with respect to the arm body 2. The motors 405 and 406 are relatively heavy. For this reason, when the arm 14 is rotated about the rotation axis O₃ with the arm 15, the motors 405 and 406 located in the arm 15 (the accommodating section 21) on the side where the root portion 25 is located make it possible to perform this rotation promptly.

The motor 405 has a rod-like shape and has a shaft (a shaft member) 405a rotatably supported about an axis thereof, and the shaft 405a protrudes toward the side where the side face 23a is located (see FIG. 11) . The motor 406 has a rod-like shape and has a shaft (a shaft member) 406a rotatably supported about an axis thereof, and the shaft 406a protrudes toward the side where the side face 23b is located (see FIG. 11).

Moreover, the drive mechanism 3 further has a first pulley 31 coupled to the shaft 405a of the motor 405, a second pulley 32 placed in the tongue-shaped portion 24a in a position away from the first pulley 31, and a belt (a timing belt) 33 stretched over the first pulley 31 and the second pulley 32. As is the case with the shaft 405a of the motor 405, the first pulley 31, the second pulley 32, and the belt 33 are located on the side where the side face 23a is located, and can rotate the wrist 16 about the rotation axis O₅ (the second pulley 32) reliably by transferring the turning force of the shaft 405a to the wrist 16.

Furthermore, the drive mechanism 3 further has, also on the side where the side face 23b is located, a first pulley 31 coupled to the shaft 406a of the motor 406, a second pulley 32 placed in the tongue-shaped portion 24b in a position away from the first pulley 31, and a belt 33 stretched over the first pulley 31 and the second pulley 32. The first pulley 31, the second pulley 32, and the belt 33 on the side where the side face 23b is located can rotate the wrist 16 about the rotation axis O₆ reliably by transferring the turning force of the shaft 406a of the motor 406 to the wrist 16.

As shown in FIG. 11, the motor 405 and the motor 406 are symmetrically placed (are symmetric with respect to a point) by using the central axis 22 of the arm body 2 as a center of symmetry (a point of symmetry). Furthermore, the first pulley 31, the second pulley 32, and the belt (the timing belt) 33 which are on the side where the side face 23a is located and are coupled to the motor 405 in order and the first pulley 31, the second pulley 32, and the belt 33 which are on the side where the side face 23b is located and are coupled to the motor 406 in order are symmetrically placed (are symmetric with respect to a point) by using the central axis 22 as a center of symmetry.

Such a symmetrical placement contributes to miniaturization of the arm 15 (the arm body 2) and makes it possible to make the range of movement of the arm 15 as wide as possible. Moreover, as will be described later, it is possible to allow the sealing unit 4 (4d) on the side where the side face 23a is located and the sealing unit 4 (4d) on the side where the side face 23b is located to have a common structure.

Next, the sealing unit 4 (4d) will be described. In the arm 15, the sealing unit 4 is provided on the side where the side face 23a is located and on the side where the side face 23b is located. Since the sealing unit 4 on the side where the side face 23a is located and the sealing unit 4 on the side where the side face 23b is located are identical in structure, the sealing unit 4 on the side where the side face 23a is located will be described as a typical example.

The sealing unit 4 hermitically seals the accommodating section 21. The sealing unit 4 provides the drive mechanism 3 (3d) inside the accommodating section 21 with resistance to water and dust. Moreover, the sterilizing gas from the sterilizing gas generating apparatus 200 sometimes corrodes the drive mechanism 3, but the sealing unit 4 can reliably prevent the corrosion.

As shown in FIGS. 7 to 9, the sealing unit 4 has a frame 5, packing 7, and a cover 6, which are stacked in this order from the side where the arm body 2 is located.

As shown in FIG. 7, the frame 5 is a frame-shaped member along an edge portion 212 of an opening 211 formed in the side face 23a (the outer surface) of the accommodating section 21 of the arm body 2. The thickness of this member can be set at about 10 mm, for example.

As shown in FIGS. 8A and 8B and FIG. 9, the frame 5 has a back side 51 bonded to the edge portion 212 via an adhesive layer (an adhesive) 70. The adhesive layer 70 is formed along the edge portion 212. This prevents a gap between the back side 51 of the frame 5 and the edge portion 212 of the arm body 2 reliably and makes it possible to ensure the hermeticity of the accommodating section 21. As described above, the adhesive layer 70 also functions as a “gasket (packing)” filling the gap between the back side 51 of the frame 5 and the edge portion 212 of the arm body 2.

In the robot 1, the frame 5 is fixed to the arm body 2 mainly by the adhesive layer 70. Furthermore, in the robot 1, a plurality of (for example, six) bolts 60 play a supplementary role in fixing the frame 5 to the arm body 2 (see FIGS. 7 and 9). This allows the frame 5 to be fixed to the arm body 2 more firmly. Moreover, when the frame 5 is fixed to the arm body 2, it is possible to fix the frame 5 temporarily with the bolts 60 until the adhesive layer 70 is cured.

The frame 5 has insertion holes 53 into which the bolts 60 are inserted, the insertion holes 53 formed from a front side 52 to the back side 51 in such a way as to penetrate the frame 5. As shown in FIGS. 7 and 12, the insertion holes 53 are placed at intervals in the circumferential direction of the frame 5. Moreover, as shown in FIG. 9, each insertion hole 53 is a “countersunk” hole and is formed of two portions having different inside diameters, that is, a larger-diameter portion 531 with a larger inside diameter on the side where the front side 52 is located and a smaller-diameter portion 532 with a smaller inside diameter on the side where the back side 51 is located. This prevents a head 601 of each bolt 60 from jutting from the front side 52 of the frame 5 and thereby makes it possible to prevent reliably the head 601 from interfering with the placement of the packing 7, which will be described later.

On the other hand, in a portion of the edge portion 212 of the arm body 2 corresponding to each insertion hole 53, an internal thread 26 is formed. The bolts 60 inserted into the insertion holes 53 of the frame 5 can thread into the internal threads 26. As a result, the above-mentioned supplementary fixing is performed.

Incidentally, as shown in FIGS. 8A and 8B and FIG. 9, in the edge portion 212 of the arm body 2, a portion in which the internal threads 26 are formed and the other portion have different thicknesses, and a thickness t₁ of the former (hereinafter referred to as a “thick portion 213”) is greater than a thickness t₂ of the latter (hereinafter referred to as a “thin portion 214”) due to the formation of the internal thread 26. However, since the area in which the thin portion 214 is formed is wider than the area in which the thick portion 213 is formed, it is possible to make the arm body 2 lighter.

The bolt 60 is not limited to a particular bolt, and, for example, it is preferable to use a so-called “hexagon socket head cap screw” which is tightened and unscrewed through use of a hexagon wrench.

As shown in FIGS. 7 and 12, in the front side 52 of the frame 5, a plurality of (for example, in the structure shown in the drawings, ten) internal threads 54 into which a plurality of (for example, in the structure shown in the drawings, ten) bolts 80 thread, the bolts 80 fixing the cover 6 to the frame 5, are formed. The internal threads 54 are placed at intervals in the circumferential direction of the frame 5. This allows the fixing force exerted by the bolts 80 to be distributed nearly evenly and makes it possible to fix the cover 6 reliably. Moreover, this allows the cover 6 to compress the packing 7 evenly between the frame 5 and the cover 6 and makes it possible to ensure the hermeticity by the packing 7 more reliably (see FIGS. 8B and 9).

Incidentally, as shown in FIGS. 8A and 8B, each internal thread 54 is preferably formed halfway through the thickness of the frame 5, that is, preferably, each internal thread 54 does not reach the back side 51.

Moreover, in the front side 52 of the frame 5, the packing 7 is placed (mounted) . As described above, the front side 52 also functions as a packing placement portion on which the packing 7 is placed.

The packing 7 placed on the front side 52 is compressed by the cover 6. At this time, in the frame 5, a compression limit for the packing 7 can be regulated by a regulating portion 55. This makes it possible to compress the packing 7 adequately and ensure the hermeticity of the accommodating section 21 suitably. Furthermore, even when the packing 7 is replaced with the new one more than once at the time of regular maintenance, for example, it is possible to reliably regulate the compression limit for the packing 7 in such a way that the compression limit becomes constant at each time of maintenance. As described above, the robot 1 facilitates maintenance.

Such a regulating portion 55 is formed as a rib that juts from the front side 52 and is formed in the circumferential direction of the frame 5. A height h of the regulating portion 55 is not limited to a particular height, and, for example, when the packing 7 has a thickness of t₃ in a natural state in which no external force is applied, the thickness t₃ is preferably compressed by 10 to 40% and, more preferably, by 20 to 30% (see FIGS. 8A and 8B). For example, when the height h is 1.5 mm, if the thickness t₃ is set at 2 mm, the packing 7 can be compressed by 0.5 mm (25%).

In the frame 5, a chamfered portion 56 obtained by chamfering a portion (at least part thereof) on the base end side, the portion of the outside edge portion of the frame 5, is formed. This makes it possible to make the cover 6 placed on the frame 5 smaller by the chamfered part of the chamfered portion 56 and make the arm 15 (the robot 1) lighter . Moreover, the chamfered portion 56 prevents interference between the arm 15 and the area surrounding the arm 15 and makes the range of movement of the arm 15 as wide as possible.

As shown in FIG. 12, when viewed from the side of the arm body 2, the frame 5 does not overlap with the motor 405, the first pulley 31, the second pulley 32, and the belt 33. As a result, when any one of the motor 405, the first pulley 31, the second pulley 32, and the belt 33 is taken out of the accommodating section 21 at the time of maintenance, it can be taken out of the accommodating section 21 easily only by pulling it toward the front side of the plane of paper of FIG. 12 (in the direction opposite to an arrow D in FIG. 7). As described above, the robot 1 facilitates maintenance.

The constituent material of the frame 5 is not limited to a particular material, and, for example, various metal materials can be used. Of these metal materials, aluminum or an aluminum alloy is preferable. When the frame 5 is obtained by being cut from a metal plate which is a base material, by using aluminum or an aluminum alloy as the constituent material of the frame 5, it is possible to perform cutting with ease. Moreover, it is possible to perform passivation or plate processing on the frame 5 easily and reliably and thereby form a first protective film 57, which will be described later, reliably.

If a frame similar to the frame 5 with the above-described structure is formed integrally with the arm body 2, the arm body 2 which is a casting increases in size by the size of the frame 5. As a result, the weight of the arm body 2 also increases, resulting in a reduction of the speed of operation of the arm body 2. However, in the robot 1, since the arm body 2 and the frame 5 are formed separately, it is possible to prevent such a problem. Moreover, it is possible to add the sealing unit 4 having the frame 5 easily to an existing robot.

Furthermore, even when the internal threads 54 of the frame 5 break, that is, the internal threads 54 are stripped due to, for example, repeated maintenance operations, by replacing only the frame 5 with the new one, it is possible to attach the cover 6 to the new frame 5 reliably and use the robot 1 safely.

As shown in FIG. 10, in the frame 5, the first protective film 57 and a second protective film 58 are formed.

The first protective film 57 is formed on at least the internal threads 54 of the frame 5 (in this embodiment, the entire surface of the frame 5). The first protective film is a film formed by performing passivation or plate processing on the frame 5. As described earlier, the sterilizing gas sometimes corrodes the drive mechanism 3, but the first protective film 57 can prevent corrosion, in particular, in the internal threads 54 reliably.

Incidentally, as passivation, anodization is preferable, and, as plate processing, electroless nickel plating is preferable. Such processing provides outstanding corrosion resistance. Moreover, when the first protective film 57 is formed, a thickness t₄ of the first protective film 57 can be controlled easily. As a result, the first protective film 57 having a desired thickness is obtained.

The thickness t₄ of the first protective film 57 is not limited to a particular thickness. For example, the thickness t₄ of the first protective film 57 is preferably 10 to 100 μm, and, more preferably, 30 to 80 μm.

The second protective film 58 is formed in a portion other than the internal threads 54 of the frame 5 (in this embodiment, a portion other than the internal threads 54 and the back side 51 of the frame 5) on the first protective film 57. The second protective film 58 is a film formed by applying a material having liquid repellency. For example, when a chemical is contained in the sterilizing gas, depending on the type of the chemical, the chemical may affect the frame 5 by adhering to the frame 5. However, the second protective film 58 can prevent the adhesion of the chemical reliably.

Incidentally, as the material having liquid repellency, it is preferable to use a fluorine material. Such a material has outstanding chemical resistance. Moreover, even when the chemical adheres to the frame 5, it is possible to wipe up the chemical with ease. Furthermore, this material also has an antifouling function, and, for example, even when dust, dirt, or oil adheres to the frame 5, it is possible to wipe up the dust, the dirt, or the oil with ease.

A thickness t₅ of the second protective film 58 is not limited to a particular thickness. For example, the thickness t₅ of the second protective film 58 is preferably 10 to 50 μm and, more preferably, 20 to 40 μm. The angle of contact between the second protective film 58 and water is not limited to a particular angle. For example, the angle of contact between the second protective film 58 and water is preferably 100 to 150 degrees and, more preferably, 100 to 120 degrees.

To the frame 5, the flat-shaped cover 6 is removably attached. The accommodating section 21 can be covered with the cover 6 in an attached state. This makes it possible to protect the drive mechanism 3 and reliably prevent the operating drive mechanism 3 from being touched by a hand or the like accidentally.

In the cover 6, in positions corresponding to the internal threads 54 of the frame 5, insertion holes 61 through which the bolts 80 are to be inserted are formed. Each insertion hole 61 is formed as a through hole penetrating the cover 6 in the thickness direction thereof. The bolts 80 inserted into the insertion holes 61 of the cover 6 can thread into the internal threads 54 of the frame 5. As a result, the cover 6 is attached to the frame 5, that is, is brought into an attached state. Incidentally, in this attached state, since the packing 7 is in a compressed state as described earlier, the hermeticity of the accommodating section 21 of the arm body 2 is maintained reliably.

Moreover, by loosening the bolts 80 from the attached state, it is possible to detach the cover 6 from the frame 5. An operator who performs maintenance of the drive mechanism 3 in a state in which the cover 6 is detached can easily perform the maintenance such as replacement of the motor 405 by inserting a finger or the like into the accommodating section 21 of the arm body 2 through the frame 5.

When the cover 6 is attached again with the bolts 80 after this maintenance, the packing 7 is brought into a compressed state, making it possible to maintain the hermeticity of the accommodating section 21 of the arm body again reliably. As described above, in the robot 1, irrespective of whether it is before or after maintenance, it is possible to maintain the hermeticity of the accommodating section 21 reliably.

The cover 6 is formed of a metal flat plate (having a thickness of about 2 mm, for example) whose whole part is flat. The metal material thereof is not limited to a particular metal material, and it is preferable to use stainless steel, for example. As a result, as compared to a case in which projections and depressions are formed on a front side 62 of the cover 6, it is possible to prevent or inhibit dust, dirt, or the like from accumulating on the front side 62. Moreover, even when dust, dirt, or the like is accumulated, it is possible to wipe up the dust, the dirt, or the like with ease.

Incidentally, the bolt 80 is not limited to a particular bolt. For example, a so-called “hexagon head bolt” which is tightened and unscrewed through use of a spanner or a so-called “hexagon socket head cap screw” which is tightened and unscrewed through use of a hexagon wrench can be used. Of these bolts, the “hexagon head bolt” is particularly preferable. Since the “hexagon head bolt” has, in a head 801 of the bolt 80, less projections and depressions than the “hexagon socket head cap screw”, dust, dirt, or the like is prevented or inhibited from being accumulated. Moreover, even when dust, dirt, or the like is accumulated, it is possible to wipe up the dust, the dirt, or the like with ease.

Between the frame 5 and the cover 6, the packing 7 in a compressed state is inserted. As is the case with the frame 5, the packing 7 is a frame-shaped member. The thickness of this member can be set at, for example, about 2 mm.

Moreover, in the packing 7, in positions corresponding to the internal threads 54 of the frame 5, insertion holes 71 through which the bolts 80 are to be inserted are formed. Each insertion hole 71 is formed as a through hole penetrating the packing 7 in the thickness direction thereof. The bolts 80 thread into the internal threads 54 of the frame 5 in a state in which the bolts 80 are inserted in the insertion holes 71 (see FIG. 8B). In this way, positioning of the packing 7 is performed.

The constituent material of the packing 7 is not limited to a particular material. Examples include various rubber materials (in particular, vulcanized rubber materials) such as styrene-butadiene rubber, nitrile rubber, chloroprene rubber, butyl rubber, acrylic rubber, ethylene propylene rubber, urethane rubber, silicone rubber, and fluorocarbon rubber and various thermoplastic elastomers such as styrene elastomer, polyvinyl chloride elastomer, polyurethane elastomer, polyester elastomer, polyamide elastomer, polybutadiene elastomer, fluorocarbon rubber elastomer, and chlorinated polyethylene elastomer, and one or two or more of these materials can be mixed together and used.

As shown in FIGS. 1 to 3 and FIGS. 13 and 14, the robot 1 includes the connector receiving portion (a robot's side connector) 8 placed on the outer surface of the arm 14. To the connector receiving portion 8, the connector (a manipulator-side connector) 9 of the connector assembly 90 is connected.

As shown in FIGS. 13 and 14, the connector receiving portion 8 has a hollow connector receiving portion body (an attachment) 81, first packing (first packing for a connector receiving portion) 82 and second packing (second packing for a connector receiving portion) 83 that maintain the hermeticity of the connector receiving portion body 81, a plurality of terminals 84, and a support member (a housing) 85 that collectively supports the terminals 84.

The connector receiving portion body 81 is a member that is formed separately from the arm 14 (the arm body 2c) and has a box-like outer shape, that is, a member having a bottom face 811, a top face 812 placed so as to face the bottom face 811, and four side faces 813 placed between the bottom face 811 and the top face 812.

Incidentally, in the structure shown in FIG. 3, the connector receiving portion body 81 is fixed to the arm 14 with a plurality of bolts 86. Internal threads 28 into which the bolts 86 thread are formed in the arm body 2c of the arm 14 (see FIGS. 13 and 14).

In the bottom face 811 of the connector receiving portion body 81, a first opening 814 that faces downward, that is, faces the outer surface of the arm 14 is formed. Moreover, in a position of the arm body 2c of the arm 14, the position facing the first opening 814, a through hole 27 penetrating a wall portion of the arm body 2c is formed. A cable 19 connected to the terminals 84, which will be described later, can reach a battery 500 through the first opening 814 and the through hole 27 in order, the battery 500 as a supply source that supplies electric power to the manipulator 18. Incidentally, the battery 500 is placed in a lower part of the base 11 of the robot 1 (see FIGS. 1 and 2).

Moreover, of the four side faces 813, in a side face 813a facing in the direction of the rotation axis O₄, that is, a tip direction, a second opening 815 that faces in that direction is formed. This makes it possible to insert the support member 85 into the second opening 815 and bring the terminals 84 supported by the support member 85 into a state in which the terminals 84 are collectively made to jut in the tip direction. A direction in which a flexible cable (a long object) 901 is drawn, the flexible cable (the long object) 901 extending from the connector 9 connected to the terminals 84 (the connector receiving portion 8), coincides with the direction of the rotation axis O₄ (see FIG. 13).

As compared to a case in which the cable 901 is drawn vertically upward, for example, such a mode in which the direction in which the cable 901 (the connector 9) is drawn coincides with the direction of the rotation axis O₄ makes it possible to route the cable 901 to the manipulator 18 easily with no consideration given to the interference between the area around the robot 1 and the cable 901 and the interference between the arms 12 and 13 and the cable 901 (see FIG. 3).

As shown in FIGS. 13 and 14, the connector receiving portion body 81 (the connector receiving portion 8) is placed above the arm 14 in a state in which the connector receiving portion body 81 (the connector receiving portion 8) is away from both the rotation axis O₃ and the rotation axis O₄.

The operating range (the rotation range) of the arm 14 is narrower than the operating range (the rotation range) of the arm 15. That is, while the arm 14 rotates about the rotation axis O₃, the arm 15 rotates about the rotation axis O₃ with the arm 14 in addition to rotating about the rotation axis O₄. As described above, for the cable 901 which is routed, providing the connector receiving portion body 81 in the arm 14 with a narrower operating range is preferable.

Moreover, if the connector receiving portion body 81 is placed above the arm 15, when the arm 15 is rotated about the rotation axis O₄, the arm 13 and the connector receiving portion body 81 interfere with each other, which makes the operating range of the arm 15 narrower. For this reason, it is preferable to provide the connector receiving portion body 81 in the arm 14.

The connector receiving portion body 81 is placed in the arm 14 in such a way that the distance between the connector receiving portion body 81 and the rotation axis O₃ is minimized. In this embodiment, in a state in which the central axis of the arm 13 and the central axis of the arm 14 intersect at right angles, the connector receiving portion body 81 is placed on the central axis of the arm 13. Incidentally, here, the central axis of the arm 13 is an axis connecting the rotation axis O₂ and the rotation axis O₃, and the central axis of the arm 14 is an axis connecting the rotation axis O₃ and the rotation axis O₅ or the central axis of the arm 14 is the rotation axis O₄.

Incidentally, the constituent material of the connector receiving portion body 81 is not limited to a particular material, and, for example, a material similar to the constituent material of the arm body 2 can be used.

In the first opening 814 of the connector receiving portion body 81, the first packing 82 is placed, and, in the second opening 815, the second packing 83 is placed.

The first packing 82 is a member that is ring-shaped and hermetically seals the boundary between the connector receiving portion body 81 and the arm 14. The second packing 83 is a member that is ring-shaped and hermetically seals the boundary between the connector receiving portion body 81 and the support member 85 inserted into the connector receiving portion body 81. With such first packing 82 and second packing 83, the hermeticity of the connector receiving portion body 81 is reliably maintained, making it possible to reliably prevent sterilizing gas or the like from entering the connector receiving portion body 81.

Incidentally, the constituent material of the first packing 82 and the second packing 83 is not limited to a particular material, and, for example, a material similar to the constituent material of the packing 7 of the sealing unit 4 can be used.

The support member 85 is formed as a cylindrical member, and the base end portion thereof is inserted in the second opening 815 of the connector receiving portion body 81.

On the inner periphery of the support member 85, a fixing plate 851 is formed in such a way as to jut therefrom. The fixing plate 851 can support and fix the terminals 84 in a direction perpendicular to the direction of the surface of the fixing plate 851.

Moreover, on the outer periphery of the support member 85, a flange 852 which is a part of the support member 85 with an increased outside diameter is formed in such a way as to jut therefrom. In the support member 85, the flange 852 is fixed to the connector receiving portion body 81 with a plurality of bolts 87. Furthermore, in this fixed state, it is possible to compress the second packing 83 by the flange 852. Internal threads 816 into which the bolts 87 thread are formed in an edge portion of the second opening 815 of the connector receiving portion body 81.

Incidentally, the constituent material of the support member 85 is not limited to a particular material, and, for example, thermoplastic resins such as polyethylene and polypropylene can be used.

Each terminal 84 has a pin-like shape, and the longitudinal center of each terminal 84 is fixed to the fixing plate 851 of the support member 85.

Incidentally, the terminal 84 is formed of a material possessing electrical conductivity such as copper.

Moreover, each terminal 84 (the connector receiving portion 8) is electrically connected to the battery 500 via the cable 19. As a result, in a state in which the connector 9 is connected to the connector receiving portion 8, it is possible to supply electric power to the manipulator 18 from the battery 500 and thereby operate the manipulator 18.

Next, the connector assembly 90 will be described. As shown in FIGS. 13 and 14, the connector assembly 90 is formed of the connector 9 and the cable 901 and is obtained by connecting the cable 901 to the connector 9. The manipulator 18 is electrically connected to the connector 9 via the cable 901.

The connector 9 has a hollow connector housing 91, first packing (first manipulator-side packing) 92 and second packing (second manipulator-side packing) 93 that maintain the hermeticity of the connector housing 91, a plurality of terminals 94, a support member 95 that collectively supports the terminals 94, and a connector receiving member 96 for connecting the connector housing 91 to the connector receiving portion 8.

The connector housing 91 is formed as a cylinder. The cable 901 can be inserted into the connector housing 91 from the tip side thereof.

The constituent material of the connector housing 91, the support member 95, and the connector receiving member 96 is not limited to a particular material, and, for example, thermoplastic resins such as polyethylene and polypropylene can be used.

On the base end side of the connector housing 91, the first packing 92 is placed, and, on the tip side of the connector housing 91, the second packing 93 is placed.

The first packing 92 is ring-shaped and is fitted onto the outer periphery of the connector housing 91. As shown in FIG. 13, in a state in which the connector 9 is connected to the connector receiving portion 8, the first packing 92 is compressed between the support member 95 and the support member 85 of the connector receiving portion 8.

Moreover, the second packing 93 is ring-shaped and is fitted into the inner periphery of the connector housing 91. The second packing 93 is compressed between the inner periphery of the connector housing 91 and the cable 901.

With such first packing 92 and second packing 93, the hermeticity of the connector housing 91 is reliably maintained, making it possible to reliably prevent gas or liquid from entering the connector housing 91 from the outside.

Incidentally, the constituent material of the first packing 92 and the second packing 93 is not limited to a particular material, and, for example, a material similar to the constituent material of the packing 7 of the sealing unit 4 can be used.

The support member 95 is formed as a cylindrical member and is inserted from the base end side of the connector housing 91. On the inner periphery of the support member 95, a fixing portion 951 is formed in such a way as to jut therefrom. The fixing portion 951 can support and fix the terminals 94 parallel to the terminals 84 of the connector receiving portion 8.

Each terminal 94 is pin-shaped and is formed of a material possessing electrical conductivity such as copper. One terminal 94 and one terminal 84 of the connector receiving portion 8 are electrically connected to each other.

Moreover, on the outer periphery of the connector housing 91, the ring-shaped connector receiving member 96 is rotatably supported about the axis of the connector housing 91. On the inner periphery of the connector receiving member 96, an internal thread portion 961 is formed. An external thread portion 853 formed on the outer periphery of the support member 85 of the connector receiving portion 8 can thread into the internal thread portion 961. As a result, a connection state between the connector 9 and the connector receiving portion 8 is reliably maintained.

Furthermore, in this connection state, it is possible to supply electric power from the battery 500 reliably to the manipulator 18 via the cable 19, the connector receiving portion 8, the connector 9, and the cable 901. This allows the manipulator 18 to move under control of the personal computer 20.

As the connector 9 with the above structure, for example, “DCA Series” manufactured by DDK Ltd. can be used. Moreover, in addition to the above connector, various “Waterproof IP67” connectors based on the IEC standards can also be used. Such a connector 9 is water-resistant, and the size thereof is relatively large due to the structure thereof.

Here, if the cable 901 is drawn vertically upward, depending on the height of the ceiling 103 of the chamber 100, there is a high risk that the cable 901 extending from the above-described large connector 9 will interfere with the ceiling 103.

However, in the robot 1 (the robot system 10), since the direction in which the cable 901 is drawn coincides with the direction of the rotation axis O₄, irrespective of whether the connector 9 is large or small, it is possible to route the cable 901 to the manipulator 18 easily with no consideration given to the interference between the area around the robot and the cable 901, that is, while preventing the above-described problem reliably.

Although the robot system and the robot of the embodiment of the invention shown in the drawings have been described, the embodiment of the invention is not limited to those described above. The portions forming the robot system and the robot can be replaced with arbitrary portions with structures having the same functions. Moreover, any structure may be added.

Moreover, the robot system and the robot of the embodiment of the invention may be obtained by combining any two or more structures (features) of the embodiment described above.

Furthermore, the number of arms of the robot of the embodiment of the invention is six in the above embodiment, but the number of arms is not limited thereto. For example, the robot of the embodiment of the invention may have two, three, four, five, or seven or more arms.

In addition, the drive mechanism may further have a speed reducer.

Moreover, the connector receiving portion may be configured to be removably attached to the arm. In this case, attachment and detachment of the connector receiving portion can be chosen in accordance with the presence or absence of an end factor.

The entire disclosure of Japanese Patent Application No. 2012-84353, filed Apr. 2, 2012 is expressly incorporated by reference herein.

What is claimed is:

1. A robot system comprising:
a connector having a hollow connector housing and packing that maintains the hermeticity of the connector housing; and
a robot provided with a connector receiving portion to which the connector is connected,
wherein the robot includes two arms coupled to each other, one arm of the two arms being supported in such a way as to be rotatable about a first rotation axis and the other arm being supported in such a way as to be rotatable about a second rotation axis intersecting the first rotation axis, and
the connector receiving portion is placed in the one arm in such a way that a direction in which the connector connected to the connector receiving portion is drawn coincides with a direction of the second rotation axis.

2. A robot provided with a connector receiving portion to which a connector is connected, the connector having a hollow connector housing and packing that maintains the hermeticity of the connector housing, the robot comprising:
two arms coupled to each other,
wherein
one arm of the two arms is supported in such a way as to be rotatable about a first rotation axis and the other arm is supported in such away as to be rotatable about a second rotation axis intersecting the first rotation axis, and
the connector receiving portion is placed in the one arm in such a way that a direction in which the connector connected to the connector receiving portion is drawn coincides with a direction of the second rotation axis.

3. The robot according to claim 2, wherein
the connector receiving portion is formed separately from the one arm and has a hollow connector receiving portion body and at least one piece of packing for a connector receiving portion, the packing maintaining the hermeticity of the connector receiving portion body.

4. The robot according to claim 3, wherein
the connector receiving portion is placed on an outer surface of the one arm, and
the connector receiving portion body has a first opening formed in such a way as to face the outer surface of the one arm and a second opening formed in such a way as to face in the direction of the second rotation axis.

5. The robot according to claim 4, wherein
the packing for a connector receiving portion is placed in the first opening and the packing for a connector receiving portion is placed in the second opening.

6. The robot according to claim 2, wherein
the other arm has one end portion to which the one arm is coupled and the other end portion to which an arm for manipulator attachment, the arm to which a manipulator electrically connected to the connector is attached, is coupled.

7. The robot according to claim 2, wherein
the other arm is a long object extending in the direction of the second rotation axis.

8. The robot according to claim 7, wherein
the connector receiving portion is electrically connected to a supply source that supplies electric power to a manipulator.

9. The robot according to claim 2, wherein
the first rotation axis and the second rotation axis intersect at right angles.

10. The robot according to claim 2, wherein
the connector housing is formed as a cylinder and the packing is placed at both ends of the cylinder.

11. A robot system comprising:
a connector having a hollow connector housing and ring-shaped packing placed on an outer periphery of the connector housing or an inner periphery of the connector housing; and
a robot provided with a connector receiving portion to which the connector is connected,
wherein
the robot includes two arms coupled to each other, one arm of the two arms being supported in such a way as to be rotatable about a first rotation axis and the other arm being supported in such a way as to be rotatable about a second rotation axis intersecting the first rotation axis, and
the connector receiving portion is placed in the one arm in such a way that a direction in which the connector connected to the connector receiving portion is drawn coincides with a direction of the second rotation axis.

12. A robot system comprising:
a cable;
a connector that includes packing and is coupled to the cable;
a first arm supported in such a way as to be rotatable about a first rotation axis;
a second arm that is coupled to the first arm and is supported in such a way as to be rotatable about a second rotation axis intersecting the first rotation axis; and
a connector receiving portion that is placed in the first arm and can be connected to the connector,
wherein
in the connector receiving portion, a direction in which the connector connected to the connector receiving portion is drawn coincides with a direction of the second rotation axis.

13. A robot connected to a connector inside which packing is provided, the robot comprising:
a first arm supported in such a way as to be rotatable about a first rotation axis;
a second arm that is coupled to the first arm and is supported in such a way as to be rotatable about a second rotation axis intersecting the first rotation axis; and
a connector receiving portion that is placed in the first arm and can be connected to the connector,
wherein
in the connector receiving portion, a direction in which the connector connected to the connector receiving portion is drawn coincides with a direction of the second rotation axis.

14. The robot according to claim 13, wherein
the connector receiving portion includes a hollow connector receiving portion body and packing for a connector receiving portion, the packing that is attached to the connector receiving portion body.

15. The robot according to claim 14, wherein
the connector receiving portion is placed on an outer surface of the first arm, and
the connector receiving portion body has a first opening formed in such a way as to face the outer surface of the first arm and a second opening formed in such a way as to face in the direction of the second rotation axis.
